(19) United States
(12) Patent Application Publication
(10) Pub. No.: US 2005/0116578 A1
(43) Pub. Date: Jun. 2, 2005

(54) Small hand-held medical drill

(75) Inventors: Christian Fleury, Bellerive (CH); Rob Ellins, Lakewood, OH (US); Manfred K. Luedi, Fort Worth, TX (US); Thierry Bieler, Morges (CH)

Correspondence Address: MEDTRONIC, INC., 710 MEDTRONIC PARKWAY NE, MS-LC340, MINNEAPOLIS, MN, 55432-5604, US

(73) Assignee: Medtronic, Inc., Minneapolis, MN (US)

(21) Appl. No.: 10/698,116

(22) Filed: Nov. 1, 2003

(51) Int. Cl. H02P 15/00; H02K 1/00; H02K 49/00

(52) U.S. Cl. 310/254; 310/216; 310/179; 310/103

(57) ABSTRACT

A surgical instrument having an electric motor is discussed. The motor includes a motor output member, a driven member and a driving member. The driven member is coupled to the motor output member. The driving member includes a winding and a magnetically conductive portion comprising a plurality of laminations. The winding can be a self-supporting winding. The driving member, or at least the magnetically conductive portion thereof, is disposed proximate the driven member such that energizing the driving member imparts motion to the driven member. At least a portion of the driven member includes a magnet material. The magnet material can have a remanence of greater than or equal to about 1 T.

### RELATED APPLICATIONS

This application is related to the commonly-assigned and concurrently filed U.S. patent application Ser. No. ______ entitled “ELECTRIC MOTOR HAVING NANOCRYSTALLINE ALLOY COMPONENT FOR USE IN SURGICAL PROCEDURE”, Attorney Docket No. 31849.41, having Thierry Bieler, Christian Koechli, Laurent Cardoletti, and Christian Fleury named as inventors, which concurrently filed application is incorporated herein by reference in its entirety.

This application is related to the commonly-assigned and concurrently filed U.S. patent application Ser. No. ______ entitled “USING THINNER LAMINATIONS TO REDUCE OPERATING TEMPERATURE IN A HIGH SPEED HAND-HELD SURGICAL POWER TOOL,” Attorney Docket No. P-11256.00US, having Rob Ellins and Christian Fleury named as inventors, which concurrently filed application is incorporated herein by reference in its entirety.

### BACKGROUND

This application relates to hand-held surgical tool systems powered by electrical motors.

An ideal hand-held surgical power tool system would be lightweight and would generate sufficient power and be sufficiently small for the task at hand. However, producing a power tool system with such features can be difficult. In part, the difficulty is because smaller motors generally produce less power than larger motors. Based on the laws of scaling, considering the same temperature rise, the relationship of diameter (d) to power is: Power is proportional to d^{3.5} (including length) and proportional to d^{2.5} if length is held constant. See Marcel Jufer (1995) 3ed, “Traite d'electricite”, Electronecanique, 3 ed., Vol. IX, page 97, formula 4.54. Thus, length and particularly diameter are important considerations in constructing an electric motor. Thus, small, ergonomic surgical instruments would be expected to be substantially less powerful than their larger counterparts.

One way to generate additional power from a small motor is to modify the materials from which motor components are made. For example, a magnet with increased remanence or energy density may be used as a portion of a rotor. One example of a magnet with a remanence and high energy density is a neodymium-iron-boron magnet. While such magnets are capable of producing a more powerful motor, increased motor speeds can result in potentially dangerous potentially dangerous situations during surgical use. For example, if a piece of a neodymium-iron-boron magnet or other magnet, which are generally delicate and brittle, were to break off of a motor in a surgical instrument during high speed use, the motor would seize, increasing the likelihood of harm to a patient. Thus, brittle or delicate components, such as a neodymium-iron-boron magnet or other magnet, while improving motor performance, may be dangerous, particularly with high-speed surgical use.

Another difficulty with producing an ideal high-speed hand-held surgical instrument is the generation of heat. One way to reduce heat generation is to introduce an active cooling system into the instrument. Such instruments may include an air or liquid cooling system. However, the introduction of an active cooling system into a hand-held tool tends to increase overall size and weight of the system. Another way to reduce heat generation is to decrease the power or speed of the motor, but this is often not an acceptable option.

Smaller instruments are desirable for ergonomic purposes, but they often sacrifice too much power. It would be desirable to produce a small surgical instrument containing a sufficiently small electric motor having performance characteristics that do not substantially suffer relative to their larger counterparts. Further, it would be desirable to produce a more powerful instrument of a size similar to existing instruments.

### SUMMARY

The present disclosure provides a description of a hand-held device and associated motor having desirable size and power characteristics for use in surgical applications. In one aspect of the description, a device having a diameter less than that of a currently available device, but which does not suffer great power loss and which has desirable heat generation characteristics, is disclosed.

In one embodiment, the invention provides a hand-held high-speed power instrument system. The system comprises an electric motor, which motor includes an output shaft, a rotor coupled to the output shaft, and a stator having a winding and a magnetically conductive portion disposed about the rotor. The rotor includes a high energy density magnet. In an embodiment, the magnet comprises neodymium-iron-boron. Use of a high energy density magnet and/or a magnet with a high remanence allows for increased power output of the system relative to a lower density or remanence magnet. The system may further include a protective sleeve or other suitable material disposed between the stator and the rotor to prevent a fragmented portion of the magnet from being projected from the rotor during use. Such a feature may be desirable for preventing the motor from ceasing during use, particularly when the motor is being operated at high speeds.

In an embodiment, the invention provides a hand-held high-speed power instrument system. The system comprises an electric motor, which motor includes an output shaft, a rotor coupled to the output shaft, and a stator having a winding and a magnetically conductive portion disposed about the rotor. The winding is a self-supporting winding. Use of a self-supporting winding according to the embodiment allows for additional coil turns to be included in the winding, the additional coil turns being present in space where a support would otherwise be located. The presence of additional coils and/or reduced space due to the absence of a coil support allows the motor to generate additional power and/or occupy less space.

In an embodiment, the invention provides a power tool system, which system includes an electric motor having an output shaft, rotor coupled to the output shaft, and a stator having a winding and a magnetically conductive portion disposed about the rotor. In an embodiment, the rotor includes a high energy density magnet and the stator includes a self-supporting winding.

In an embodiment, the invention provides an electrical motor including a motor output member, a driven member and a driving member. The driven member is coupled to the motor output member. The driving member includes a winding and a magnetically conductive portion disposed proximate the driven member such that energizing the driving member imparts motion to the driven member. In an embodiment, the driven member comprises a high energy density magnet or magnet portion. In an embodiment, the winding is a self-supporting winding. In an embodiment, the driven member comprises a high energy density magnet or magnet portion and the winding is a self-supporting winding.

Motors and instruments as described herein may provide several advantages. For example, when used in surgical applications, the instruments described herein can reduce surgery time and increase ease of surgery. Because motors and instruments including the motors as described herein can be made of a smaller size without a great sacrifice in power, a surgeon can use the smaller instrument for similar purposes as larger instruments without the surgeon experiencing as much hand fatigue. Further, smaller instruments may be more useful than their larger counterparts for particular applications as will be recognized by one of skill in the art. In addition, as will be discussed herein, smaller diameter instruments may have improved heat generation profile characteristics relative to their larger counterparts. Thus smaller instruments with smaller motors may be used for longer times, not only because of ergonomic considerations, but also because a surgeon may require less or no breaks at all during surgery to allow the instrument to cool down. These and other advantages will be evident to those skilled in the art based on the description herein.

The foregoing has outlined preferred and alternative features of several embodiments so that those skilled in the art may better understand the detailed description that follows. Additional features will be described below that further form the subject of the claims herein. Those skilled in the art should appreciate that they can readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 illustrates a perspective environmental view of a surgical instrument for the dissection of bone and other tissue according to aspects of the present invention.

FIG. 2 illustrates a perspective view of one embodiment of the surgical instrument shown in FIG. 1.

FIG. 3 illustrates a perspective view of one embodiment of an electric motor constructed according to aspects of the present invention.

FIG. 4 illustrates a self-supporting winding according to an aspect of the invention.

FIG. 5 is a photograph of a self-supporting winding according to an aspect of the invention.

FIG. 6 illustrates a perspective view of another embodiment of the electric motor shown in FIG. 3.

FIG. 7 illustrates a perspective view of another embodiment of an electric motor constructed according to aspects of the present invention.

FIG. 8 illustrates an exploded perspective view of one embodiment of an electric disc motor constructed according to aspects of the present invention.

FIG. 9 illustrates an elevation view of one embodiment of an electric linear motor constructed according to aspects of the present invention.

FIG. 10 is a side view of a section of portion of a surgical instrument according to aspects of the present invention.

FIG. 11 is a graph of thermal cross comparison data of surgical instruments having motors with stator laminations of differing thicknesses and having different diameters.

FIG. 12 is a graph of motor performance of instruments having different diameters.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over, on or coupled to a second feature in the description that follows may include embodiments in which the first and second features are formed in direct contact, and may also include embodiments in which additional features may be formed interposing the first and second features, such that the first and second features may not be in direct contact.

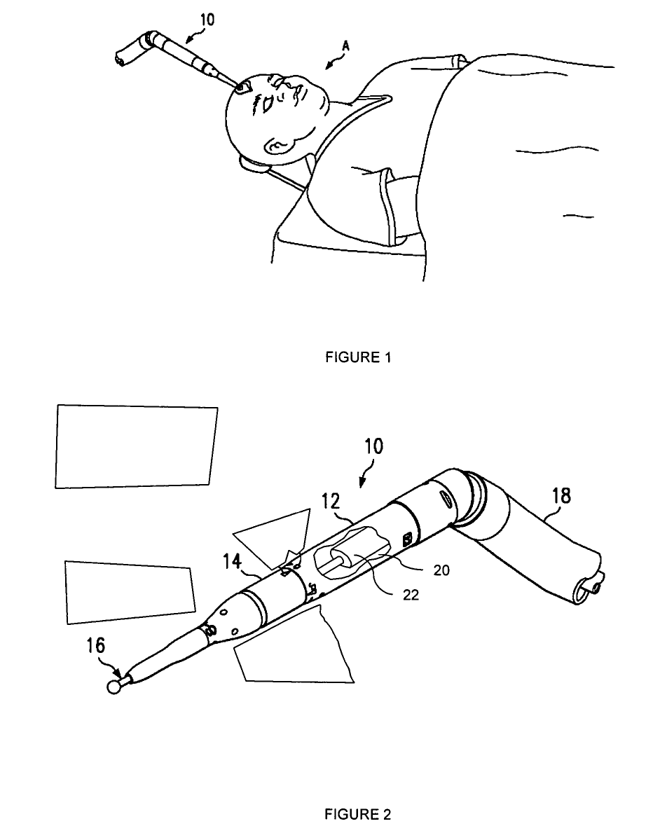

Referring to FIG. 1, illustrated is a perspective environmental view of one embodiment of a surgical instrument 10 for the dissection of bone and other tissue according to aspects of the present disclosure. The surgical instrument 10 is shown operatively associated with a patient A for performing a craniotomy. It will become apparent to those skilled in the art that the described instrument is not limited to any particular surgical application but has utility for various applications in which it is desired to dissect bone or other tissue. Additional applications include:
1. Arthroscopy—Orthopaedic
2. Endoscopic—Gastroenterology, Urology, Soft Tissue
3. Neurosurgery—Cranial, Spine, and Otology
4. Small Bone—Orthopaedic, Oral-Maxiofacial, Ortho-Spine, and Otology
5. Cardio Thoracic—Small Bone Sub-Segment
6. Large Bone—Total Joint and Trauma
7. Dental.

Referring to FIG. 2, illustrated is a perspective view of one embodiment of the surgical instrument 10 shown in FIG. 1. The surgical instrument 10 is illustrated to generally include a motor assembly 12, an attachment housing 14 and a surgical tool 16. The attachment housing 14 may provide a gripping surface for use by a surgeon and may also shield underlying portions of the instrument 10 during a surgical procedure. In a preferred embodiment, the surgical tool 16 is a cutting tool or dissection tool, although the type of tool is not essential to implementing the present disclosure.

The surgical instrument 10 is shown connected to a power cord assembly 18 for providing a source of electrical power to the motor assembly 12. It is further understood, however, that embodiments of the surgical instrument 10 according to aspects of the present disclosure will have equal application for a battery powered surgical instrument, such that the surgical instrument 10 may alternatively or additionally include disposable and/or rechargeable batteries. In such embodiments, the batteries may be housed within the motor assembly 12, or may be a separate, discrete component or subassembly. For example, the power cord assembly 18 shown in FIG. 2 may alternatively be a battery module containing one or more batteries.

The attachment housing 14 is adapted and configured to engage the motor assembly 12. The surgical tool 16 may be inserted into attachment housing 14 for engaging with the motor assembly 12. The motor assembly 12 includes an internal cavity 20 adapted and configured to contain a motor 22. Embodiments of the motor 22 are described in further detail below. In general, the motor 22 is coupled to the surgical tool 16 such that rotary or linear motion of the motor 22 may be imparted to the surgical tool 16.

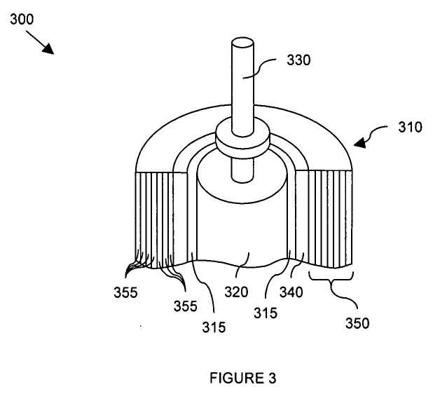

Referring to FIG. 3, illustrated is a perspective view of one embodiment of an electric motor 300 constructed according to aspects of the present disclosure. The electric motor 300 may be implemented for surgical environments, including those represented by FIGS. 1 and 2 and the corresponding description above. The electric motor 300 includes a stator 310, a rotor 320 and an output shaft 330 coupled to the rotor 320. In general, the rotor 320 is disposed within the cavity formed by the stator 310, such that the rotor 320 may rotate within the stator 310 in response to electric and/or magnetic fields generated by the stator 310 and/or the rotor 320.

The rotor 320 comprises a magnet or a magnet component and may be formed by machining, casting, molding and/or other processes. Any magnet material may be used. For example, neodymium iron boron, aluminum nickel cobalt, samarium cobalt and the like may be used as magnet material. The magnet or magnet component may comprise nanocrystalline material. The magnet material may be formed by any suitable method such as compression molding, injection molding, sintering, hot pressing, etc. In an embodiment, the magnet or magnet component has an energy density of about 225 kJ/m³ or greater. Typically, neodymium iron boron magnets can posses such energy densities. In another embodiment, the magnet or magnet component has an energy density of about 250 kJ/m³ or greater. In an embodiment, the magnet or magnet component has an energy density of about 260 kJ/m ³ or greater. In various embodiments, the magnet or magnet component has a remanence of about 1 T or greater, about 1.1 T or greater, about 1.15 T or greater, or about 1.18 T or greater. When the motor 300 is to be incorporated into a surgical instrument, it is preferred that the magnet have a sufficiently high remanence after being subject to autoclave temperatures. Care should also be taken to prevent corrosion of the magnet or magnet component, which can be accomplished by coating the surface of the magnet material with a layer of; for example, nickel, a zinc, tin, gold, copper, epoxy, parylene, etc., or combinations thereof. Any one or more of such coating layers may be applied to a magnet or magnet component in accordance with the invention. With high energy density magnets such as neodymium iron boron magnets, which are fragile and delicate, care should be taken to ensure that minimal impurities are introduced to the material. E.g., gloves should be worn when handling to prevent possible finger print contamination and solutions and equipment with which the magnet may come into contact should be clean.

In one embodiment, the output shaft 330 and the rotor 320 are integrally formed. As discussed above, the output shaft 330 may also be configured to engage a surgical tool. For example, the output shaft 330 may include half of a pin/socket coupling or other means for rigidly but detachably securing a surgical tool. However, any conventional or future-developed output shaft 330, surgical tool and means for coupling thereof may be employed within the scope of the present disclosure.

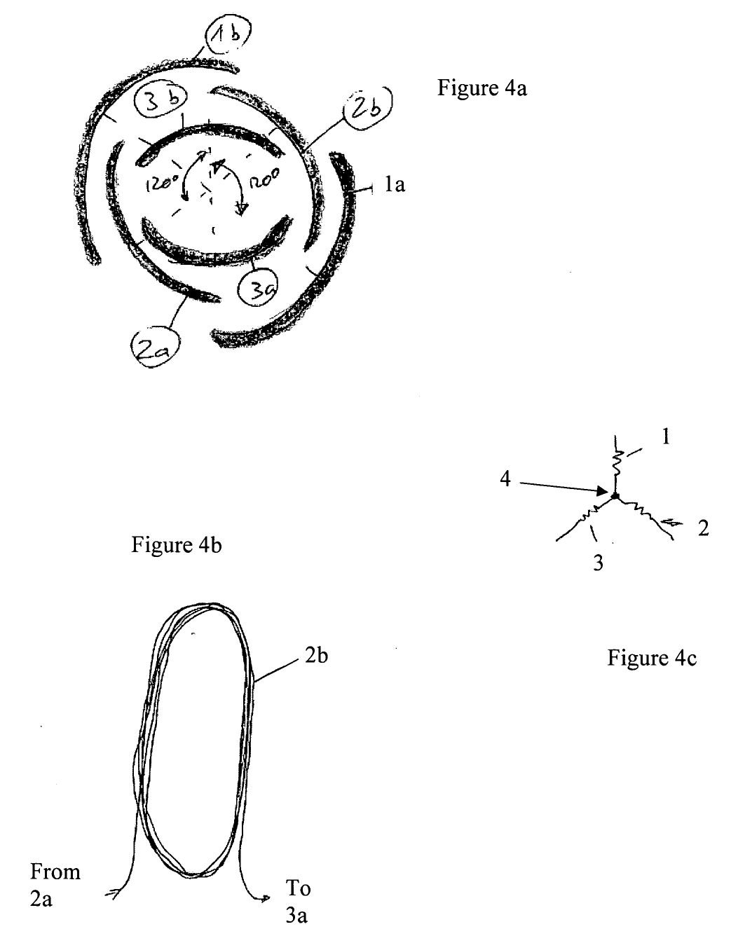

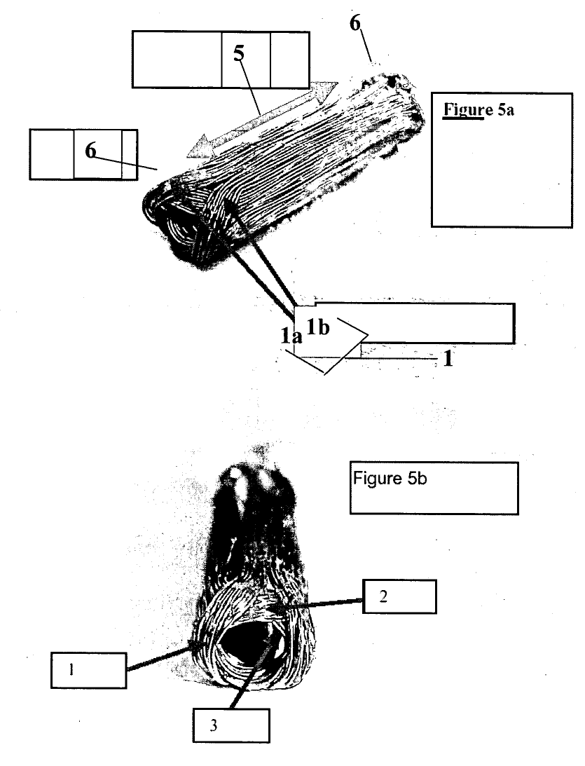

The stator 310 includes at least one winding 340 coupled to a magnetically conductive portion 350. The winding(s) 340 may be of conventional composition and manufacture, such as a plurality of electrically conductive coils. However, the scope of the present disclosure does not limit the particular nature of the winding(s) 340, such that any conventional or future-developed windings may be employed according to aspects of the present disclosure. In one embodiment, the windings are self-supporting windings. Self supporting windings 340 are wound on a external structure, such as a mandrel, and then affixed to the stator 310. Self supporting windings include Faulhaber windings, as disclosed in U.S. Pat. No. 3,360,668, which patent is herein incorporated by reference in its entirety, rhombic windings (Maxon Motors), concentric windings such as in the SMOOVY motor (RMB), other windings such as the winding shown in FIGS. 4 and 5, and the like. Referring to FIG. 4a, an exploded top view of a self-supporting winding 10 (referred herein to as “self-supporting winding A”) is shown. Self-supporting winding A 10 consists of three coils, each of which consists of two semi coils. Coil 1 consists of semi-coils 1a and 1b, coil two consists of semi-coils 2a and 2b, and coil 3 consists of two semi-coils 3a and 3b. The coils are overlapped to optimize use of available space and increase coil volume within a space. FIG. 4b illustrates a side view of self-supporting winding A 10 looking at semi-coil 2b. Electrically conductive coil of the winding 10 from semi-coil 2a enters semi-coil 2b an exits to form semi-coil 3a. In general each semi-coil may comprise any suitable number of turns. In an embodiment, each semi-coil comprises 17 turns. As shown in FIG. 4c, the three coils 1, 2, and 3 are connected in a “star” fashion at a floating common point 4. Referring to FIG. 5, a photograph of self-supporting winding A 10 is shown in both FIGS. 5a and 5b. As shown in FIG. 5a, two semi-coils (e.g., 1a and 1b) make one coil (e.g. 1). FIG. 5a also shows an active zone 5 of the winding that is substantially the same length as the magnetically conductive portion 350 of the stator 310. Self-supporting winding A 10 also comprises coil end turn zones 6. FIG. 5b is a photograph illustrating the three coils 1, 2, and 3 of self-supporting winding A 10.

The coils of a winding 340 may be any electrically conductive material. Typically the coils comprise copper, gold, siver or aluminum wire. In an embodiment, the coils comprise a substantially rectangular shaped electrically conductive material. The rectangular shape allows for the coil to occupy more of a volume within a given space than a rounded coil. After being formed a self-supporting winding 340 may be affixed to the magnetically conductive portion 350 of the stator 310 by any suitable means, such as glue, epoxy, thermoplastic varnish, etc. In an embodiment, the wire of the coil is covered with a thermoplastic varnish, which also serves to electrically insulate one portion of the coil from another portion.

The winding(s) 340 are electrically insulated from the magnetically conductive portion 350. The winding(s) 340 may be selectively connectable to an electrical power source, such as the power cord/battery assembly 18 shown in FIG. 1, such as by an electrical switch.

The magnetically conductive portion 350 may comprise any suitable magnetically conductive material. In an embodiment, the magnetically conductive portion 350 comprises an alloy, such as an iron-based alloy. Iron-based alloys include iron-nickel alloys, iron-cobalt alloys, iron-cobalt-vanadium alloys, iron-nickel cobalt alloys, cobalt-iron alloys, and the like. The ratio of iron in an iron alloy may be changed to affect the properties of the alloy. Thus, a particular alloy most suitable for the intended use may be selected. In an embodiment, the alloy is an iron-nickel alloy. The iron-nickel alloy may contain any suitable percentage of iron and nickel. In an embodiment, the iron-nickel alloy comprises between about 45% and about 55% iron and between about 45% and about 55% nickel. The alloy may be a nanocrystalline alloy.

As shown in FIG. 3, the magnetically conductive portion 350 may comprise a plurality of laminations 355 each concentric to the winding 340 (and, thus, also concentric to the rotor 320, in the illustrated embodiment). The laminations may be any be of any suitable thickness. In an embodiment, the laminations 355 may each have a thickness less than about 0.25 mm. Employing a lamination 355 having a thickness of less than about 0.25 mm as at least a portion of the magnetically conductive portion 350 may reduce the generation of Eddy currents within the stator. Accordingly, losses conventionally deleterious to the efficiency and other performance characteristics of electric motors may be substantially reduced or eliminated by forming at least a portion of the stator 310 from a lamination having a thickness of less than about 0.25 mm. In an embodiment, one or more of the laminations 355 have a thickness of less than or equal to about 0.2 mm. In an embodiment, one or more of the laminations 355 have a thickness of less than or equal to about 0.15 mm. In an embodiment, one or more of the laminations 355 have a thickness of less than or equal to about 0.1 mm. In an embodiment, the thickness of the laminations 355 ranges from between about 100 nm and about 100 μm. Of course, any individual or aggregate thickness of the layers 355 is within the scope of the present disclosure. In an embodiment, each lamination 355 has substantially the same thickness.

The electric motor 300 may operate at any speed. Speeds of 1,000,000 rpm or higher are contemplated. Typically, motors 300 according to various embodiments of the invention will be operated at speeds ranging between about 100 rpm and about 100,000 rpm.

The laminations 355 may be formed by any suitable process, which are well-known in the art. For example, laminations may be formed from ribbon-shaped alloy material, such as that available from Imphy Ugine Precision, headquartered in La Defense, France, and Vacuumschmelze GmbH & Co. KG of Hanau, Germany. The ribbon-shaped alloy material may be punched into lamination sheets of a size and design suitable for the desired motor. The lamination sheets may then be annealed to optimize magnetically conductive characteristics for the intended use of the motor. Annealing typically consists of heating the lamination sheets to an elevated temperature. Conditions such as time, temperature, dew point, and atmosphere conditions may be varied to achieve desired magnetic characteristics. A surface oxide layer is preferably developed on the laminations 355. The surface oxide layer acts as an electrical insulator and will provide resistance to Eddy current flow between the laminations. The annealed lamination sheets may be stacked to the desired height (core length) and held together by bolting, welding, or other means of interlocking to form at least a portion of the magnetic portion 350 of the stator 310. When preparing laminations 355 less than about 0.25 mm thick, care should be taken to not to deform the laminations, particularly after annealing.

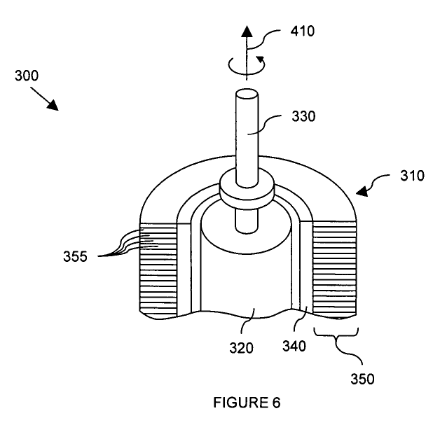

Referring to FIG. 6, illustrated is a perspective view of another embodiment of the electric motor 300 shown in FIG. 3. In general, the embodiments shown in FIGS. 3 and 6 may be substantially similar. However, in contrast to the concentric nature of the laminations 355 of the magnetically conductive portion 350 shown in FIG. 3, the laminations 355 of the embodiment shown in FIG. 6 are substantially orthogonal to the axis of rotation 410 of the rotor 320. In other words, the laminations 355 may be radially stacked, as shown in FIG. 3, or axially stacked, as shown in FIG. 6. Of course, any other variation of orientation of the laminations 355 relative to the axis of rotation 410 of the rotor 320 may be employed in a motor, and the orientation of the laminations 355 may vary within a magnetically conductive portion 350 of a stator 310.

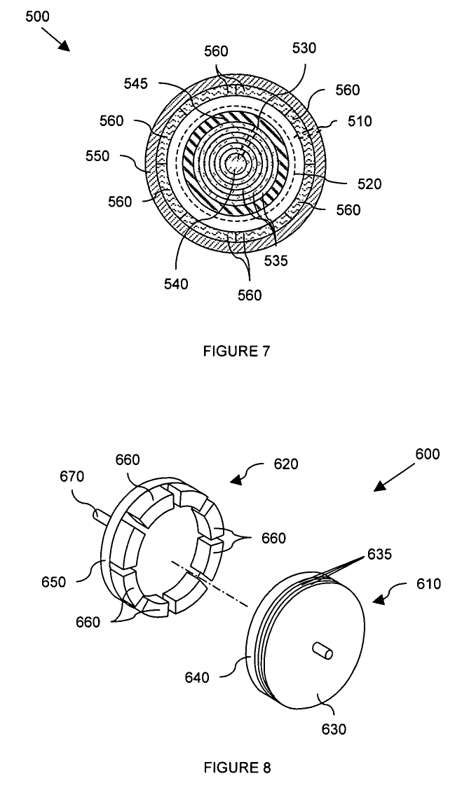

Referring to FIG. 7, illustrated is a plan view of another embodiment of an electric motor 500 constructed according to aspects of the present disclosure. In general, the electric motor 500 shown in FIG. 7 may be substantially similar to the electric motor 300 shown in FIG. 3. However, in contrast to the internal nature of the rotor 320 shown in FIG. 3, the electric motor 500 includes an external rotor 510. That is, the rotor 510 is disposed and configured to rotate about an internal stator 520. The stator 520 may be substantially similar in composition and manufacture to the stator 310 shown in FIG. 3. For example, the stator 520 includes a magnetically conductive portion 530 comprising a plurality of laminations 535. The laminations 535 may be formed around a core 540, which may be also be employed for connecting the electric motor 500 to surrounding structure (e.g., interior structure of the motor assembly 12 shown in FIG. 1). Moreover, as with the embodiments discussed above with reference to FIGS. 3 and 4, although FIG. 7 illustrates the laminations 535 as being radially stacked, the laminations 535 may also be axially stacked, stacked in an orientation between axial and radial, combinations thereof, etc. The stator 520 also includes at least one winding 545 disposed around the magnetically conductive portion 530.

The external rotor 510 may include a structural member 550 and one or magnets or magnetic components 560 (hereafter collectively referred to as the magnetic components 560) formed on or otherwise coupled to an interior surface of the structural member 550. The inner diameter of the external rotor 510 is configured such that the orientation of the magnetic components 560 relative to the internal stator 520 provides the desired interaction between the electric and/or magnetic field generated by the magnetic components 560 and/or the stator 520. In response to this interaction, the external rotor 510 will rotate around the internal stator 520, possibly at speeds up to about 1,000,000 rpm.

Referring to FIG. 8, illustrated is an exploded perspective view of another embodiment of an electric motor 600 constructed according to aspects of the present disclosure. The electric motor 600 includes a substantially disc-shaped stator 610 and a substantially disc-shaped rotor 620. The stator 610 includes a magnetically conductive portion 630 comprising a plurality of laminations 635, as in the embodiments described above. The stator 610 also includes at least one conventional or future-developed winding 640 located around the circumference of the magnetically conductive portion 630. The winding(s) 640 may also or alternatively be located on or recessed within a surface of the magnetically conductive portion 630 facing the rotor 620.

The rotor 620 includes a structural portion 650 having one or more magnets or magnetic components 660 (hereafter collectively referred to as the magnetic components 660) adhered or otherwise coupled to a surface of the structural portion 650 facing the stator 610. As shown in FIG. 8, the magnetic components 660 may collectively form a substantially disc-shaped annulus. The rotor 620 may also include an output shaft 670 coupled to or formed integrally with the structural portion 650, wherein the output shaft 670 may be substantially similar to the shaft 330 described above with reference to FIG. 3.

The embodiment shown in FIG. 8 may be particularly advantageous in applications in which higher torque and lower speeds are desired.

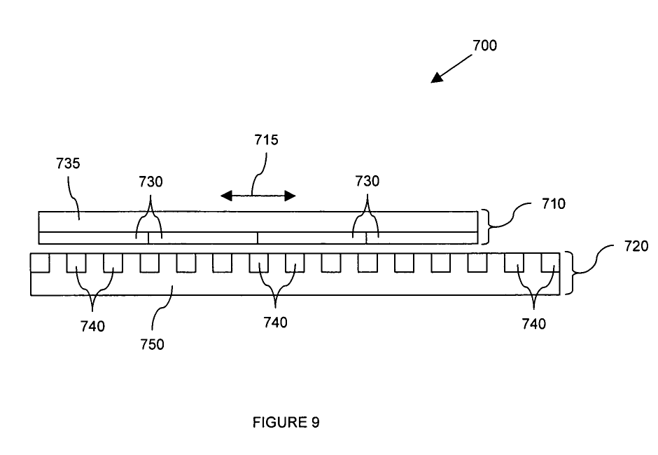

Referring to FIG. 9, illustrated is an elevation view of another embodiment of an electric motor 700 constructed according to aspects of the present disclosure. However, whereas the embodiments of the electric motors discussed above generally contemplate rotary motors, the electric motor 700 shown in FIG. 9 contemplates a linear motor. Apart from this distinction, the electric motor 700 may be substantially similar to the electric motor 300 shown in FIG. 3.

For example, the electric linear motor 700 comprises a linearly displaceable actuator 710 which may be substantially similar in composition and manufacture to the rotor 320 shown in FIG. 3. The electric linear motor 700 also includes a stator 720 which may be substantially similar in composition and manufacture to the stator 310 shown in FIG. 3.

The actuator 710 also includes at least one magnet or magnetic component 730 (hereafter collectively referred to as the magnetic components 730) coupled to a structural portion 735. The stator 720 includes a substantially planar winding 740 and a magnetic portion 750 disposed proximate the magnetic components 730 such that energizing the winding 740 imparts linear motion to the actuator 710, possibly in the direction of the arrow 715. As in the embodiments discussed above, the magnetic portion 750 comprises a plurality of laminations.

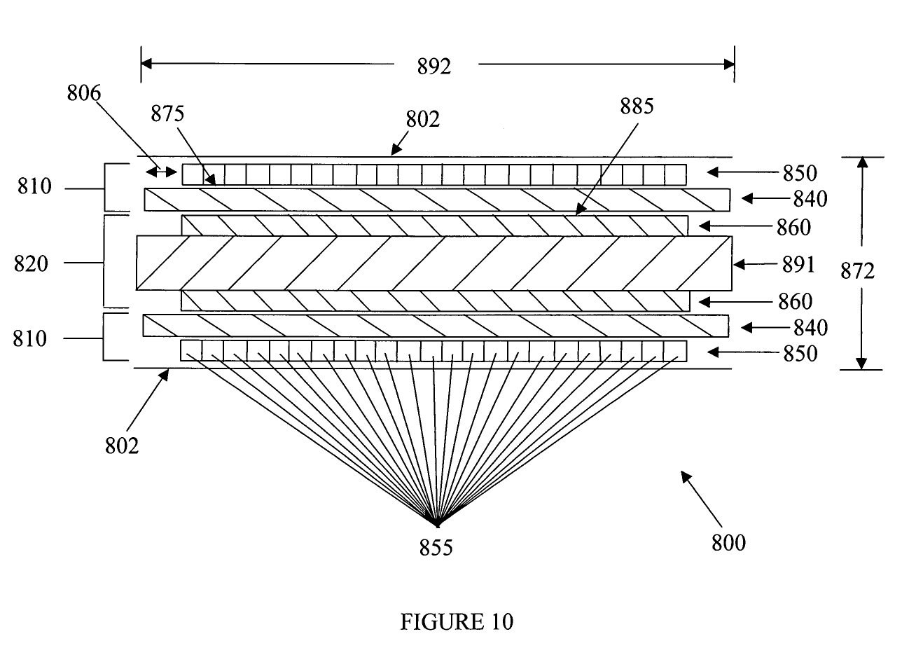

Referring to FIG. 10, illustrated is a side view of a section of a portion of a surgical instrument 800 constructed according to aspects of the present disclosure. The portion of the instrument 800 shown in FIG. 10 corresponds roughly to the motor assembly 12 portion shown in FIG. 2. The instrument 800 shown in FIG. 10 has a motor constructed similarly to that shown in FIG. 6. However, it will be recognized that any motor configuration described herein may be adapted for use with an instrument 800 as shown in FIG. 10. In FIG. 10, the motor comprises a stator 810 and a rotor 820. In the portion of the instrument 800 shown in FIG. 10, the rotor 820 is disposed within a cavity formed by the stator 810, such that the rotor 820 may rotate within the stator 310 in response to electric and/or magnetic fields generated by the stator 810 and/or the rotor 820. The rotor 820 comprises a structural portion 891 and a magnet portion 860. The stator 810 comprises a magnetically conductive portion 850 and a winding 840. As in FIG. 6, the windings 840 in FIG. 10 comprise coil end turns 806. The magnetically conductive portion 850 comprises a plurality of laminations 855. The laminations are of a thickness as discussed above. Preferably, there is an insulating layer 875 disposed between the magnetically conductive portion 850 of the stator 810 and the winding(s) 840. In addition, there may be a protective layer 885, such as a protective sleeve, between the winding(s) 840 and the magnetic portion(s) 860 of the rotor 820. Preferably the protective layer 885 is formed of non-magnetic material. In an embodiment, the protective layer 885 comprises brass. A protective layer 885 may be desirable when the magnetic portion(s) 860 of the rotor 820 are brittle and/or when the instrument 800 is to be operated at high speeds.

In FIG. 10, the stator 810 is fitted within a cavity formed by a surface 802 of the instrument 800. The outside diameter 872 formed by the surface 802 of the instrument 800 of the region of the instrument 800 housing the motor may be any size necessary to house an appropriate motor. However, as discussed above, the size of the instrument 800 is an important practical concern. Thus preferably, the outside diameter 872 of the instrument 800 in a region housing the motor is not substantially larger than that of currently available instruments. More preferably, the outside diameter 872 is substantially the same as or smaller than that of currently available surgical instruments. In an embodiment, the outside diameter 872 of the region housing the motor is less than about 30 mm. In an embodiment, the outside diameter 872 of the region housing the motor is less than about 25 mm. In an embodiment, the outside diameter 872 of the region housing the motor is less than about 20 mm. In an embodiment, the outside diameter 872 of the region of the instrument 800 housing the motor is less than about 16 mm. In an embodiment, the outside diameter 872 of this region is in the range of between about 15 mm and about 16 mm. In addition, it is preferred that the length 892 of the stator 810 is not substantially larger than that of motors used in currently available surgical instruments. (Note that the length 892 of the stator 810 includes coil end turn zones 806.) More preferably, the length 892 of the stator 810 is substantially the same as or smaller than that of motors used in currently available surgical instruments. In an embodiment, the length 972 of the stator 810 is less than about 100 mm. In an embodiment, the length 972 of the stator 810 is less than about 60 mm. In an embodiment, the length 972 of the stator 810 is less than about 50 mm. In an embodiment, the outside diameter 872 of this region is in the range of between about 40 mm and about 50 mm.

The various aspects described above are applicable to, or may readily be adapted to, many electric motor applications, including embodiments not explicitly described or illustrated herein. For example, the electric motors shown in FIG. 3-6 may be 2-pole, 4-pole or otherwise configured motors. The aspects of the present disclosure are also applicable to motors having any operating speed or range thereof, although the benefits of such aspects will be better recognized at higher operating speeds. The aspects of the present disclosure are also applicable to motors of any size and capable of producing any amount of torque.

Although embodiments of the present disclosure have been described in detail, those skilled in the art should understand that they may make various changes, substitutions and alterations herein without departing from the spirit and scope of the present disclosure.

### EXAMPLES

The following examples are provided to illustrate specific embodiments of the invention only, and should not be construed as limiting the scope of the invention.

### Example 1

### Heat Generation Profile of Smaller Diameter Instrument is More Desirable than that of Larger Diameter Instrument

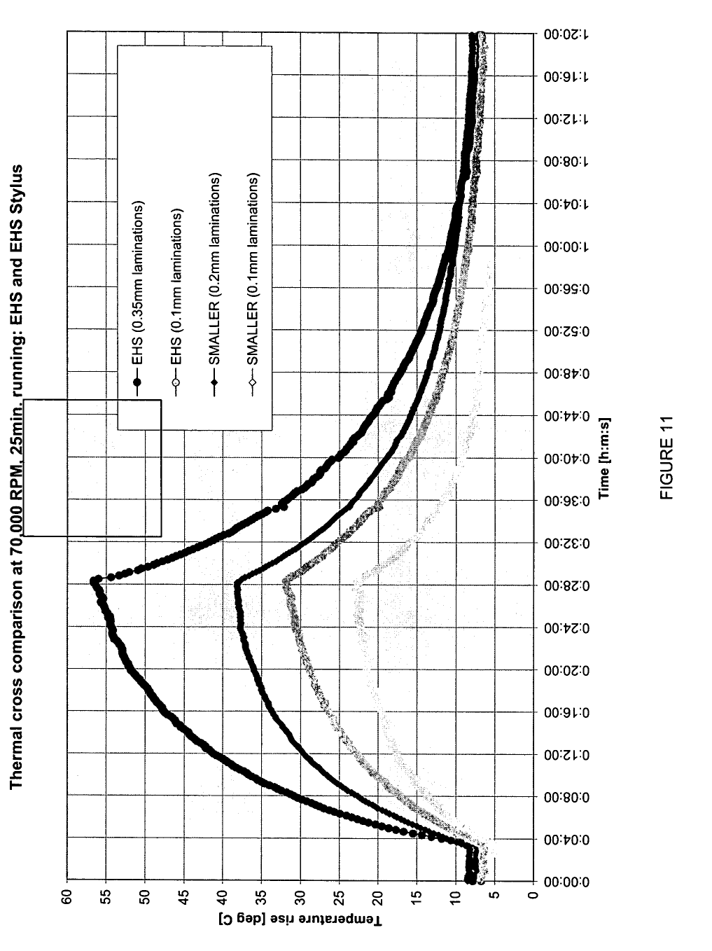

Surgical instruments based on Medtronic Midas Rex Model EHS high speed instrument, which has a diameter of about 21 mm in the portion housing the motor, and an instrument with smaller diameter, which has a diameter of 15.35 mm, were built. The instruments were built with motors having laminations of varying thickness. Instruments with laminations having a thickness of 0.1 mm were built and compared to Medtronic Midas Rex 's currently available EHS high speed instrument, whose motor has stator laminations 0.35 mm thick. Motors having 0.1 mm thick stator laminations were housed in the housing of Midas Rex Model EHS high speed instrument. In addition, motors having 0.2 and 0.1 mm thick stator laminations were constructed and housed in a casing having an outside diameter of 15.35 mm (“SMALLER” as referred to in FIG. 11). The motors in the “SMALLER” instrument were configured substantially as shown in FIG. 6. The rotor included a magnet as shown in FIG. 10. The magnet was a neodymium iron boron magnet having an energy density of 263 kJ/m³. The stator included a magnetically conductive portion and a winding. The winding was a self-supporting winding as shown in FIGS. 4 and 5 and was made of a copper coil. The magnetically conductive portion of the stator included a plurality of laminations, and the motors in the “SMALLER” instruments differed essentially only with respect to their lamination thickness (i.e., 0.1 mm thick vs. 0.2 mm thick).

Motor output of Medtronic Midas Rex EHS-based instruments were measured for both the currently available 0.35 mm thick stator laminations and for 0.1 mm thick laminations. Both torque and power output at various speeds (rpm) were similar for instruments with motors having stator lamination thicknesses of 0.35 mm and 0.1 mm (data not shown). Thus, output performance was not adversely affected by reducing lamination thickness.

A thermal cross test was performed on EHS-based instruments having stator lamination thicknesses of 0.35 mm and 0.1 mm and on the “SMALLER” instruments having stator lamination thicknesses of 0.2 mm and 0.1 mm. The instruments were run at 70,000 revolutions per minute (rpm) for 25 min. Temperature measurements were taken just before the instruments were run (time 0:00:00), throughout the 25 min. period, and up to 100 min. after the start of the test (time 1:20:00). As shown in FIG. 11, the peak temperature rise of the EHS-based instrument with 0.1 mm thick stator laminations was about 25° C. less than that of the EHS-based instrument with 0.35 mm thick stator laminations (about 32° C. and about 57° C., respectively). In addition, the peak temperature rises of the SMALLER instruments with 0.2 mm thick stator laminations and 0.1 mm thick were about 38° C. and about 23° C., respectively.

As can be seen from the data presented in FIG. 11, the instrument having the smaller diameter in the region housing the motor has a more favorable temperature generation profile than the instrument having the larger outer diameter in a region housing the motor. That is, the SMALLER instrument having a diameter of 15.35 mm in the region housing the motor had a peak temperature rise of about 9° C. less than that of the EHS based instrument, which has a diameter of about 21 mm in the region housing the motor (about 23° C. and about 32° C., respectively). It is believed that the difference in heat generation between the two instruments having different diameters is due to decreased iron losses in the smaller diameter instrument. Thus, maintaining a small diameter in a surgical instrument is not only desirable for ergonomic purposes, but also it is desirable from the aspect of heat generation. It should be noted that the heat generation profiles, as shown in FIG. 11, were created under essentially no load conditions. While the relative heat generation profiles may change at different loads, the no load condition serves as a simple model.

FIG. 11 further shows that instruments having motors with thinner laminations exhibit more desirable heat generation profiles. As shown by the shape of the curves representing temperature rise over time in FIG. 11, the temperature increase of the instruments having thinner laminations (0.2 mm and 0.1 mm thick) begins to flatten out at about 25 minutes of operation. Thus, it is possible that much longer operation times would have little effect on increasing temperature further. As such, a threshold temperature beyond which the instrument becomes too hot for a surgeon to continue to use the instrument may not be reached with the instruments having thinner laminations. No breaks in surgery may be required with instruments with thinner stator laminations. In addition, curves for the SMALLER instruments with smaller diameters tend to flatten out more quickly than those with larger diameters (EHS). Generally, curves for the SAMLLER instruments flatten out after about 30 min of being run at 70,000 rpm, while the curves for the EHS instruments do not flatten out as quickly.

In light of the above, it is clear that surgeons will be provided significant advantages when using surgical instruments with electric motors having thinner laminations.

### Example 2

### Power Profile of Smaller Diameter Instrument with Improved Motor is not Substantially Reduced Relative to Larger Diameter Instrument

Motor performance of an EHS instrument having 0.35 mm thick stator laminations (as described in Example 1) and two SMALLER instruments having 0.1 mm thick stator laminations (as described in Example 1) were compared. Power was tested by measuring torque at various speeds in dynamic fashion.

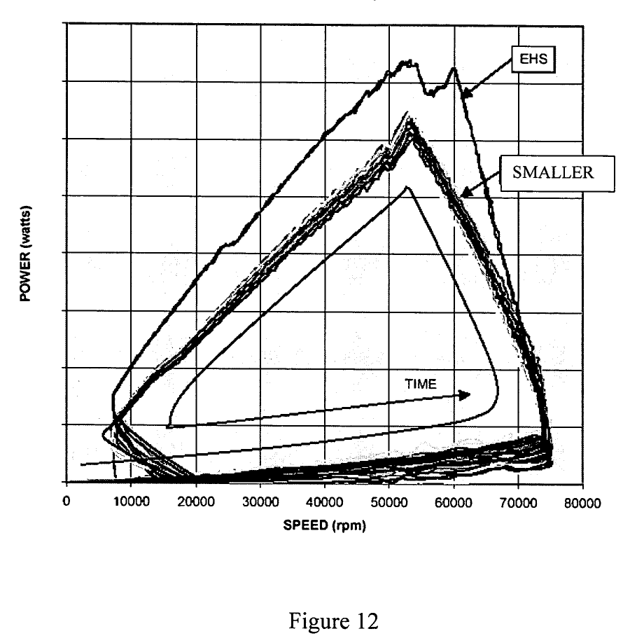

Results of the relative motor performance comparison are shown in FIG. 12. The SMALLER instruments had a peak power output roughly 85% to 87% of that of the EHS instrument. Such results are very impressive given that the diameter of the SMALLER instruments are 73% of that of the EHS instruments (15.35 mm vs. 21 mm). Holding everything else equal (including motor length), motor diameter (d) is related o power as follows: Power is proportional to d^{2.5}. Thus, if motor components were not altered in the smaller instruments, one would have expected the power performance of the SMALLER instruments to be about 55% of that of the EHS instrument (0.79^{2.5}=0.55). It will be recognized that housing thickness and air gap may impose mechanical limitations on the ability to reduce diameter. It will also be recognized that the above relationship between power and motor diameter does not take into account friction on bearings in the instrument and motor. None-the-less, a much better than theoretical result was achieved due to the component and configuration changes employed in the motors of the SMALLER instruments relative to the EHS instrument. Clearly a higher energy density magnet and/or self-supporting winding provide desirable power performance results. Such impressive results are unexpected. Further, as discussed in Example 1, the smaller diameter of the SMALLER instruments provides favorable heat generation characteristics.

1. A surgical instrument, comprising:
a housing;
an electrical power source;
an output shaft extending from the housing;
a rotor coupled to the output shaft,
wherein at least a portion of the rotor comprises a magnet having a remanence greater than or equal to about 1 T; and
a stator having:
a winding selectively connectable to the electrical power source; and
a magnetically conductive portion disposed about the rotor and comprising a plurality of laminations;
wherein selectively connecting the electrical power source and the stator windings imparts rotary motion to the output shaft via the rotor.

2. The surgical instrument of claim 1, further comprising a protective layer disposed between the stator and the rotor.

3. The surgical instrument of claim 1, wherein the protective layer comprises brass.

4. The surgical instrument of claim 1, wherein the remanence of the magnet is greater than or equal to about 1.15 T.

5. The surgical instrument of claim 1, wherein the remanence of the magnet is greater than or equal to about 1 T after being autoclaved.

6. The surgical instrument of claim 1, wherein the magnet is a neodymium-iron-boron magnet.

7. The surgical instrument of claim 1, wherein the winding is a self-supporting winding.

8. The surgical instrument of claim 7, wherein the self-supporting winding is selected from the group consisting of a Faulhaber winding, a rhombic winding, concentric windings, or a self-supporting winding A.

9. The surgical instrument of claim 8, wherein the self-supporting winding is a self-supporting winding A.

10. The surgical instrument of claim 8, wherein the winding comprises a rectangular shaped conductive element.

11. The surgical instrument of claim 8, wherein the winding comprises a conductive element and a thermoplastic element, wherein the thermoplastic element is disposed about the conductive element.

12. The surgical instrument of claim 1, wherein each of the plurality of stator laminations has a thickness of less than about 0.25 mm.

13. The surgical instrument of claim 1, wherein the housing, at least in a portion housing the stator, has an outer diameter of less than about 30 mm.

14. The surgical instrument of claim 13, wherein the housing, at least in a portion housing the stator, has an outer diameter of less than about 25 mm.

15. The surgical instrument of claim 14, wherein the housing, at least in a portion housing the stator, has an outer diameter of less than about 20 mm.

16. The surgical instrument of claim 15, wherein the housing, at least in a portion housing the stator, has an outer diameter of less than about 16 mm.

17. The surgical instrument of claim 15, wherein the housing, at least in a portion housing the stator, has an outer diameter of between about 15 mm and about 16 mm.

18. The surgical instrument of claim 13, wherein the stator has a length of less than about 100 mm.

19. The surgical instrument of claim 18, wherein the stator has a length of less than about 60 mm.

20. The surgical instrument of claim 19, wherein the stator has a length of less than about 50 mm.

21. The surgical instrument of claim 19, wherein the stator has a length in the range of between about 40 mm and about 50 mm.

22. A surgical instrument, comprising:
a housing;
an electrical power source;
an output shaft extending from the housing;
a rotor coupled to the output shaft; and
a stator having:
a winding selectively connectable to the electrical power source, wherein the winding is a self-supporting winding; and
a magnetically conductive portion disposed about the rotor and comprising a plurality of laminations;
wherein selectively connecting the electrical power source and the stator windings imparts rotary motion to the output shaft via the rotor.

23. The surgical instrument of claim 22, wherein the self-supporting winding is selected from the group consisting of a Faulhaber winding, a rhombic winding, concentric windings, or a self-supporting winding A.

24. The surgical instrument of claim 23, wherein the self-supporting winding is a self-supporting winding A.

25. The surgical instrument of claim 23, wherein the winding comprises a rectangular shaped conductive element.

26. The surgical instrument of claim 23, wherein the winding comprises a conductive element and a thermoplastic element, wherein the thermoplastic element is disposed about the conductive element.

27. The surgical instrument of claim 22, wherein each of the plurality of stator laminations has a thickness of less than about 0.25 mm.

28. The surgical instrument of claim 22, wherein the housing, at least in a portion housing the stator, has an outer diameter of less than about 30 mm.

29. The surgical instrument of claim 28, wherein the housing, at least in a portion housing the stator, has an outer diameter of less than about 25 mm.

30. The surgical instrument of claim 29, wherein the housing, at least in a portion housing the stator, has an outer diameter of less than about 20 mm.

31. The surgical instrument of claim 30, wherein the housing, at least in a portion housing the stator, has an outer diameter of less than about 16 mm.

32. The surgical instrument of claim 31, wherein the housing, at least in a portion housing the stator, has an outer diameter of between about 15 mm and about 16 mm.

33. The surgical instrument of claim 28, wherein the stator has a length of less than about 100 mm.

34. The surgical instrument of claim 28, wherein the stator has a length of less than about 60 mm.

35. The surgical instrument of claim 29, wherein the stator has a length of less than about 50 mm.

36. The surgical instrument of claim 29, wherein the stator has a length in the range of between about 40 mm and about 50 mm.

37. An electric motor for use in a surgical procedure, comprising:
a motor output member;
a driven member coupled to the motor output member; and
a driving member having a winding and a magnetically conductive portion disposed proximate the driven member such that energizing the driving member imparts motion to the driven member,
wherein at least a portion of the driven member comprises a magnet having a remanence greater than or equal to about 1 T, and
wherein the winding is a self-supporting winding.

38. The electric motor of claim 37, wherein each of the laminations have a thickness of less than or equal to about 0.20 mm

39. The motor of claim 37, wherein the motor is adapted for placement in an instrument having an outside diameter of less than about 25 mm.

40. The motor of claim 39, wherein the motor is adapted for placement in an instrument having an outside diameter of less than about 20 mm.

41. The motor of claim 40, wherein the stator has a length of less than about 50 mm.
